(19) United States
(12) Patent Application Publication
(10) Pub. No.: US 2005/0105793 A1
(43) Pub. Date: May 19, 2005

(54) Identifying a target region of a three-dimensional object from a two-dimensional image

(75) Inventors: Ron Sorek, Kurkur (IL); Michal Inselbuch, Kiryat Mozkin (IL)

Correspondence Address: DR. MARK FRIEDMAN LTD.;c/o Bill Polkinghorn, Discovery Dispatch, 9003 Florin Way, Upper Marlboro, MD, 20772, US

(73) Assignee: RAFAEL - ARMAMENT DEVELOPMENT AUTHORITY LTD.

(21) Appl. No.: 10/974,685

(22) Filed: Oct. 28, 2004

(30) Foreign Application Priority Data
Nov. 10, 2003 (IL) 158810

(51) Int. Cl. G06K 9/00

(52) U.S. Cl. 382/154

(57) ABSTRACT

A method for identifying a target region of a three-dimensional object in a two-dimensional image using a predetermined three-dimensional computer model which includes a number of main features of the three-dimensional object. The method includes designating the target region on the computer model, capturing a real scene which includes at least part of the three-dimensional object, displaying a two-dimensional representation of the real scene together with a view of the computer model, and allowing a user to manipulate the computer model by sizing, translating, or rotating. A view of the computer model and a partial view of the three-dimensional object are superimposed, in order to identify the target region in the two-dimensional representation.

### FIELD AND BACKGROUND OF THE INVENTION

The present invention relates to a system and method for identifying a three-dimensional object and, in particular, it concerns a method for identifying features of a three-dimensional object viewed in a two-dimensional image.

Reference is now made to FIG. 1, which is a view of a display 10 showing a two-dimensional image of a vehicle 12 for illustrating a first problem in accordance with the prior art. By way of illustration, a point of interest on the roof of vehicle 12 needs to be located either physically or on display 10. However, due to the persepctive of the vehicle 12 as viewed on display 10 or visually distracting features or other factors which influence human perception, it is very difficult to identify whether the point of interest is identified by point A, point B or point C or another point on the roof of vehicle 12.

Reference is now made to FIG. 2, which is a view of a display 14 showing a two-dimensional image of a vehicle 16 partially obscured by a tree 18 for illustrating a second problem in accordance with the prior art. By way of illustration, the point of interest of vehicle 16 is in this case hidden by tree 18. Similarly, the point of interest may be on a part of vehicle 16 which is out of view, i.e. on the far side of the object from the viewing direction, or outside the field of view of the imaging device. Additionally, other factors, such as noisy or low-resolution images may hinder precise identification of a point of interest.

It is known in the field of automated recognition systems to automatically identify an object in a two-dimensional by correlation to a rotatable three-dimensional computer model of the object. An example of such a system is taught by U.S. Pat. No. 6,002,782 to Dionysian. The aforementioned system is only operative under very controlled operating conditions (low noise, low distortion and without obscuration) and cannot mimic the human brain's abilities to identify objects under adverse image conditions. Dionysian is fully automated and does not provide an assistive tool or method for facilitating designation of a region on an object by a human user.

There is therefore a need for a system and method for facilitating user designation of a region of a three-dimensional object viewed in a two-dimensional image. It would also be highly advantageous to provide such a system and method which would be operative even where there exist unfavorable image conditions.

### SUMMARY OF THE INVENTION

The present invention is a system for identifying features of a three-dimensional object viewed in a two-dimensional image and a method of operation thereof.

According to the teachings of the present invention there is provided, a method for identifying a target region of a three-dimensional object in a two-dimensional image using a predetermined three-dimensional computer model which includes a plurality of main features of the three-dimensional object, comprising the steps of: (a) designating the target region on the computer model; (b) capturing a real scene which includes at least part of the three-dimensional object; (c) diplaying a two-dimensional representation of the real scene together with a view of the computer model; and (d) allowing a user to manipulate the computer model by at least one of sizing, translating and rotating, such that a view of the computer model and at least a partial view of the three-dimensional object are substantially superimposed, in order to identify the target region in the two-dimensional representation.

According to a further feature of the present invention, there is also provided the step of sending data of the target region in the two-dimensional representation to an automated system.

According to a further feature of the present invention, there is also provided the step of adjusting a level of detail of the computer model.

According to a further feature of the present invention, there is also provided the step of adjusting lighting conditions of the computer model.

According to the teachings of the present invention there is also provided a method for identifying a physical position of a region of a three-dimensional object from a two-dimensional image including the three-dimensional object using a predetermined three-dimensional computer model which includes a plurality of main features of the three-dimensional object, comprising the steps of: (a) capturing a real scene which includes at least part of the three-dimensional object; (b) displaying a two-dimensional representation of the real scene together with a view of the computer model; and (c) allowing a user to manipulate the computer model by at least one of sizing, translating and rotating, such that a view of the computer model and at least a partial view of the three-dimensional object are substantially superimposed, in order to identify the physical position of the region of the three-dimensional object.

According to a further feature of the present invention, there is also provided the step of designating the region on the computer model.

According to a further feature of the present invention, there is also provided the step of sending data of the physical position of the region to an automated system.

According to a further feature of the present invention, there is also provided the step of adjusting a level of detail of the computer model.

According to a further feature of the present invention, there is also provided the step of adjusting lighting conditions of the computer model.

According to the teachings of the present invention there is also provided a system for facilitating user designation of a target region of a three-dimensional object viewed in a two-dimensional image using a predetermined three-dimensional computer model which includes a plurality of main features of the three-dimensional object, the system comprising: (a) a camera configured for capturing a real scene which includes at least part of the three-dimensional object; (b) a computer system having a processor, display device and input device, the camera being operationally connected to the computer system, wherein the processor is configured: (i) to display on the display device a two-dimensional representation of the real scene together with a view of the computer model; (ii) to respond to a user input via the input device so as to allow a user to manipulate the view of the computer model by at least one of sizing, translating and rotating; and (iii) to receive a designation input from the user indicative that a current view of the computer model and the at least partial view of the three-dimensional object are substantially superimposed, thereby determining a position of the target region of the three-dimensional object.

According to a further feature of the present invention, there is also provided an automated system operationally connected to the computer system, the automated system configured for processing data of the target region.

According to a further feature of the present invention, the input device and the processor are configured for allowing a user to adjust a level of detail of the computer model.

According to a further feature of the present invention, the input device and the processor are configured for allowing a user to adjust lighting conditions of the computer model.

### BRIEF DESCRIPTION OF THE DRAWINGS

The invention is herein described, by the way of example only, with reference to the accompanying drawings, wherein:

FIG. 1 is a view of a display showing a two-dimensional image of a vehicle for illustrating a first problem in accordance with the prior art;

FIG. 2 is a view of a display showing a two-dimensional image of a vehicle partially obscured by a tree for illustarting a second problem in accordance with the prior art;

FIG. 3 is a schematic view of a system for facilitating user designation of a region of an object in a two-dimensional image that is constructed and operable in accordance with a preferred embodiment of the present invention;

FIG. 4 is a view of the display system of FIG. 3 showing a two-dimensional image of a vehicle partially obscured by a tree and a three-dimensional computer model of the vehicle;

FIGS. 5 and 6 are view of the display of FIG. 4 showing the computer model after increasing degrees of rotation;

FIG. 7 is a view of the display of FIG. 6 showing the computer model after a reduction in size;

FIG. 8 is a view of the display of FIG. 7 showing the computer model after translation;

FIG. 9 is a view of the display of FIG. 8 showing the computer model and the vehicle superimposed;

FIGS. 10a to 10c are views of a computer model with increasing levels of detail for use with the system of FIG. 2; and

FIGS. 11a to 11c are views of the display of FIG. 2 showing various lighting condition of a computer model.

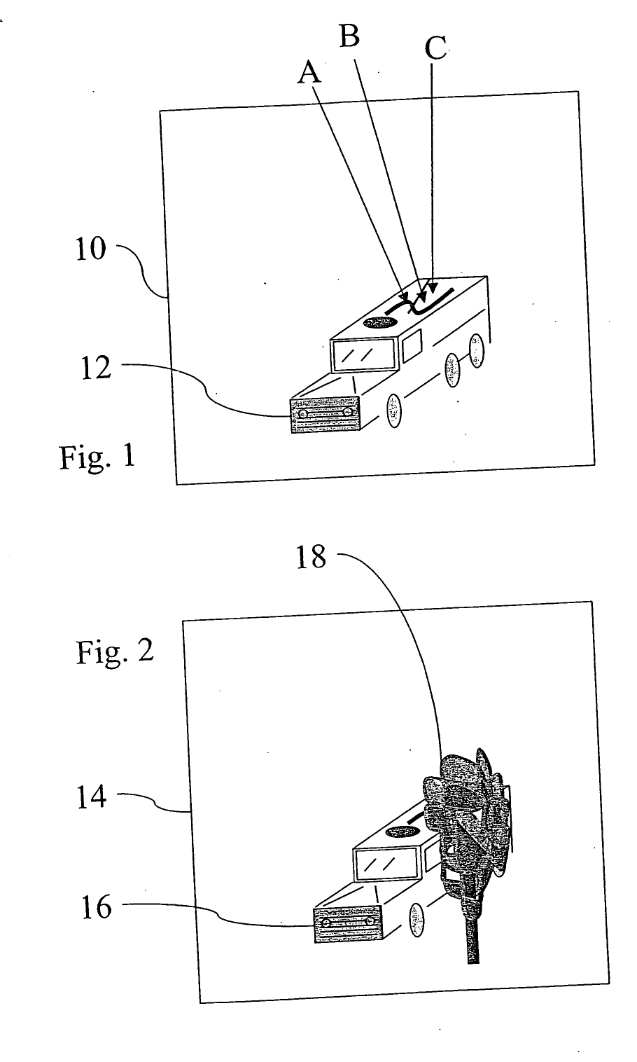

### DESCRIPTION OF THE PREFERRED EMBODIMENTS

The present invention is a system for identifying features of a three-dimensional object viewed in a two-dimensional image and a method of operation thereof.

The principals and operation of a system and a method for identifying features of a three-dimensional object viewed in a two-dimensional image according to the present invention may be better understood with reference to the drawings and the accompanying description.

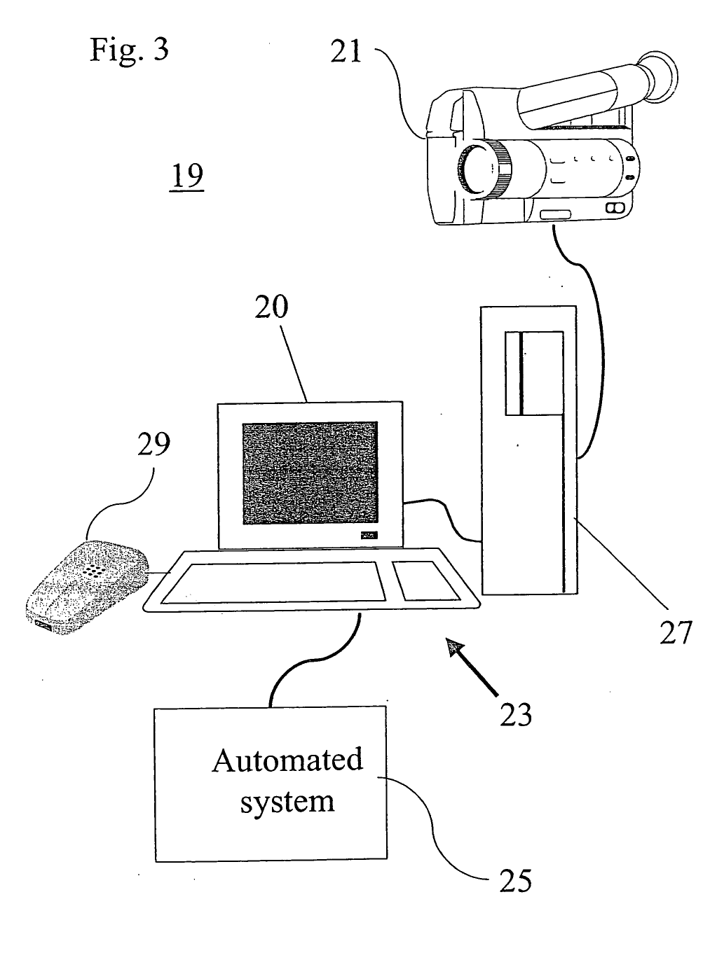

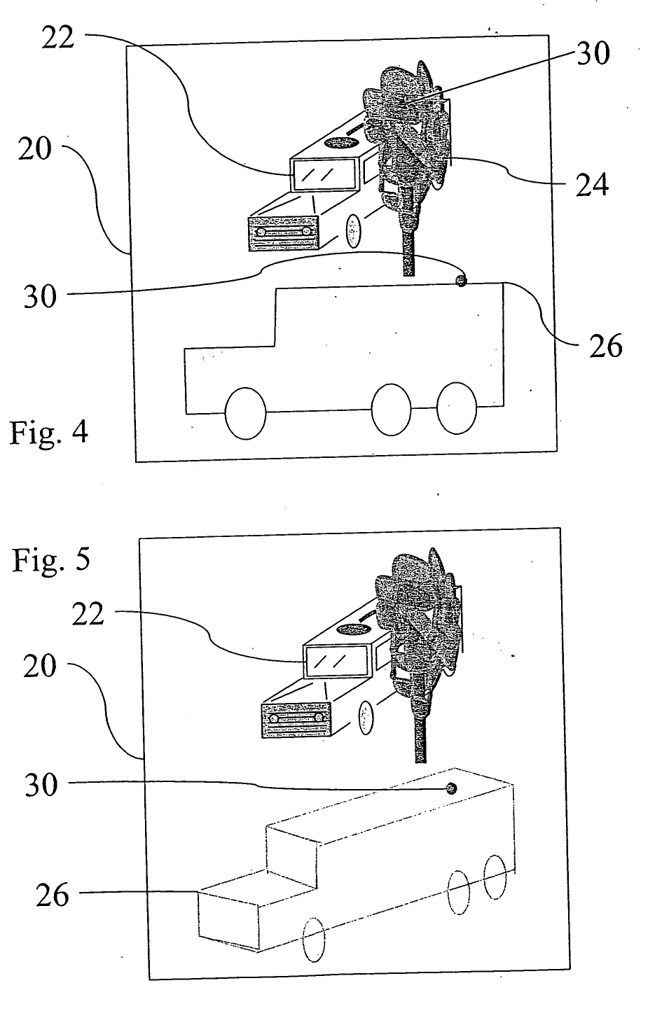

Reference is now made to Fig. 3, which is a schematic view of a system 19 for facilitating user designation of a region of an object in a two-dimensional image that is constructed and operable in accordance with a preferred embodiment of the present invention. System 19 includes a camera 21, a computer system 23 and an automated system 25. Camera 21 and automated system 25 are operationally connected to computer system 23. Computer system 23 includes a processor 27, a display device 20 and an input device 29. Camera 21 is configured for capturing real scenes. Processor 27 is configured for processing images captured by camera 21 as well as processing inputs from input device 29. Additionally, processor 27 is configured for processing outputs for display 20 and automated system 25. Automated system 25 is described in more detail with reference to FIG. 9. Display 20 is configured for displaying a two-dimensional representation of a real scene together with a view of a computer model as will be described in more detail with reference to FIG. 4. Input device 27, is typically a pointing device, such as a mouse or joystick, configured for allowing a user to manipulate a computer model as viewed on display 20 as will be described in more detail with reference to FIG. 4. Reference is additionally made to FIG. 4, which is a view of display 20 showing a two-dimensional image of a vehicle 22 partially obscured by a tree 24 and a three-dimensional computer model 26 of the vehicle that is constructed and operable in accordance with a preferred embodiment of the present invention. By way of introduction, the method of the present invention is typically performed in order to identify target region of a three-dimensional object, such as a point 30 on the roof of vehicle 22, in the two-dimensional image using the predetermined computer model 26. Alternatively, the method of the present invention is preformed in order to identify a physical position of a target region of a three-dimensional object, such as point 30 on the roof of vehicle 22, from the two-dimensional image using the predetermined three-dimensional computer model 26. It should be noted that point 30 on the roof of vehicle 22 is, in this example, obscured by tree 24. The two-dimensional image is generally captured by camera 21 and displayed on display 20. The term “physical position” is defined herein to include a physical location relative to camera 21 or another frame or reference of angular displacement from the optical axis of camera 21 or another similar frame of reference. It should be noted that, in order to determine the relative physical location of point 30, the magnification of camera 21 as well as the direction of the optical axis of camera 21 need to be known. The three-dimensional object being observed is of a known form and/or type and computer model 26 generally includes a plurality of main features of the three-dimensional object. Computer model 26 is typically defined in CAD format or other suitable three-dimensional computer model format. Computer model 26 is manipulated by input device 29 to allow the user to generate arbitrary perspective views of the object described by computer model 26 displayed on display 20. The method of the present invention includes the following steps. First, the target region, point 30, is designated on computer model 26 of the vehicle (best seen in FIG. 5). The target region is typically a region, a point or pixel. As computer model 26 is capable being manipulated by input device 29, it is relatively straightfoward to designate the target region on computer model 26. Next, a real scene including at least part of the three-dimensional object, in our example vehicle 22, is captured by camera 21. A two-dimensional representation of the real scene together with a view of computer model 26 is displayed on display 20. The term “a view of computer model 26” is defined herein to include at least part of a view of the computer model 26. For example, when vehicle 22 is viewed at close range it is preferable that only part of computer model 26 is viewable on display 20.

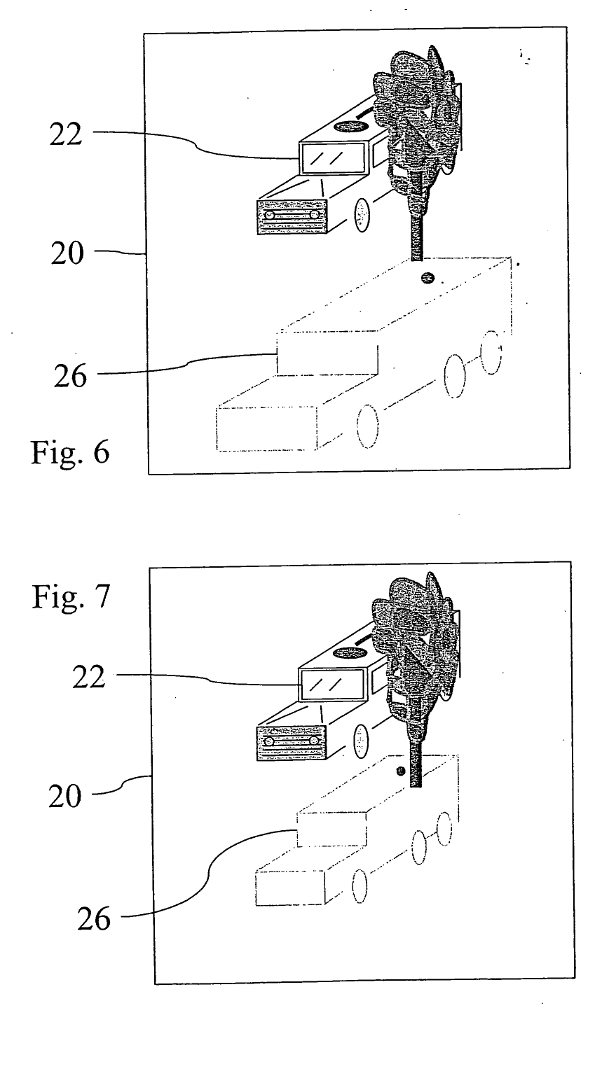

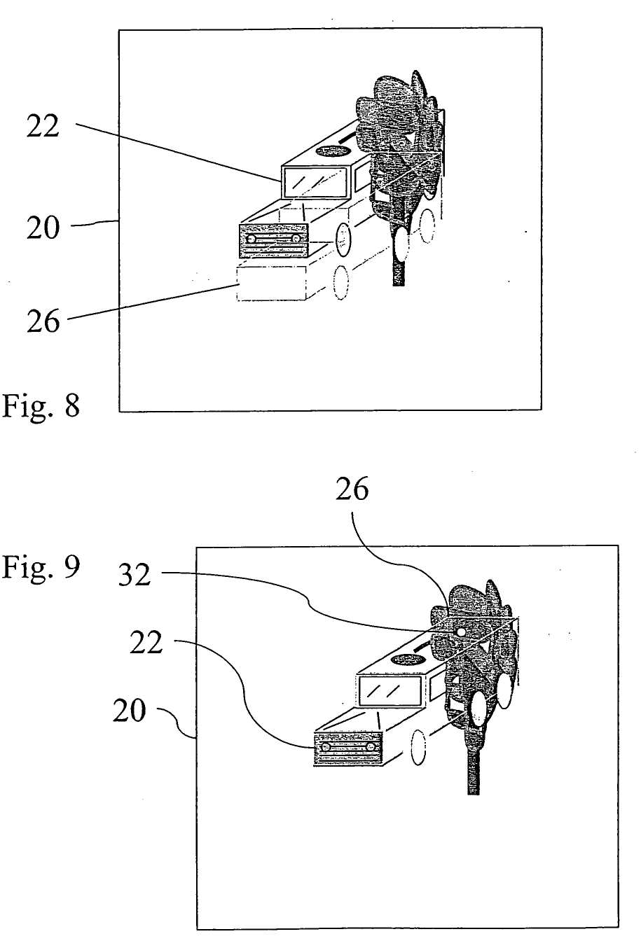

Reference is now made to FIGS. 5 to 9, which are views of display 20 of FIG. 4 showing computer model 26 after rotation FIGS. 5 and 6), reduction in size (FIG. 7) and translation (FIG. 8) until computer model 26 and vehicle 22 are superimposed (FIG. 9). A user is allowed to manipulate computer model 26 using input device 29 by sizing, translating and/or rotating, such that a view of computer model 26 and at least a partial view of the three-dimensional object, in our example, vehicle 22, are substantially superimposed. The term “substantially superimposed” is defined herein to include superimposing those features of vehicle 22 which are visible to the user in the two-dimensional representation and those features of computer model 26 displayed on display 20, such that a best fit between computer model 26 and vehicle 22 is seen by user. It should be noted that the resolution of designation of the position of the computer model 26 is not necessarily the same as the resolution of the two-dimensional image, for example, but not limited to, where the two-dimensional image has particularly low resolution the user may be able to achieve sub-pixel resolution using visual clues such as grayscale or color information. Also, it should be noted that computer model 26 is typically superimposed on top of vehicle 22. However, it will be appreciated by those ordinarily skilled in the art that vehicle 22 and computer model 26 can be combined by partial transparency or other image combining algorithms generally known in the field of image processing. The magnification of vehicle 22 as view on display 20 is automatically linked to the size of computer model 26 as displayed on display 20 the computer model, so when the user zooms in on (or vice-versa) vehicle 22, the size computer model 26 is automatically adjusted.

Once computer model 26 and vehicle 22 are substantially superimposed, the user sends a designation input to processor 27 by pressing a button on input device 29. The designation input is indicative that the current view of computer model 26 and the at least partial view of the three-dimensional object, in our example vehicle 22, are substantially superimposed. The target region is thereby identified in the two-dimensional representation. The target region is generally identified by a highlighted region 32 on display 20 (FIG. 9). Highlighted region 32 may include one or more pixels, or sub-pixel resolution. Additionally, the physical position of the target region is identifiable by analyzing the position, orientation and size of computer model 26 on display 20. As defined above, the “physical position” may be defined relative to the camera, relative to a platform upon which the camera is mounted or, where sufficient additional cameral position data is available, as an absolute location in a geo-stationary frame of reference. It will be appreciated by those skilled in the art that point 30, or any other desired point or region, can be designated on computer model 26 after computer model 26 and vehicle 22 are superimposed.

Optionally, once computer model 26 and vehicle 22 are substantially superimposed, the data of the physical position of the target region and/or the size and position of the target region within the two-dimensional representation is sent to an automated system 25 (FIG. 3). Here too, the data may either be in the form of a position in the two-dimensional view or a corresponding vector direction from the camera, or in the form of data sufficient to indicate directly, or allow derivation of, a position and orientation of the object and its target region in three-dimensional space. Automated system 25 may be fully-automated or semi-automated system, for civilian or military applications, which requires input of a precisely designated target region to be used in performing any subsequent task.

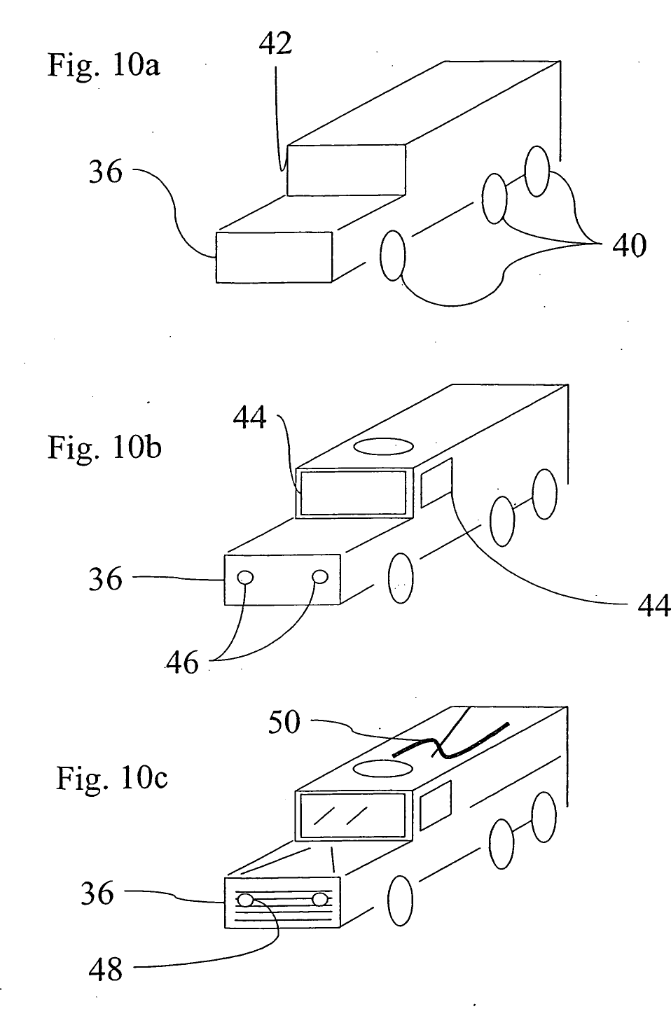

Reference is now made to FIGS. 10a to 10c, which are views of a computer model 36 with increasing levels of detail for use with the system of FIG. 2. The level of detail of computer model 36 is generally adjustable. For example, computer model 36 may include only basic skeletal features for example, but not limited to, wheel 40 and body 42 outlines (FIG. 10a). Alternatively, computer model 36 may include more features, for example, but not limited to, headlights 44, window outlines 46 (FIG. 10b), as well as grills 48 and an aerial 50 (FIG. 10c).

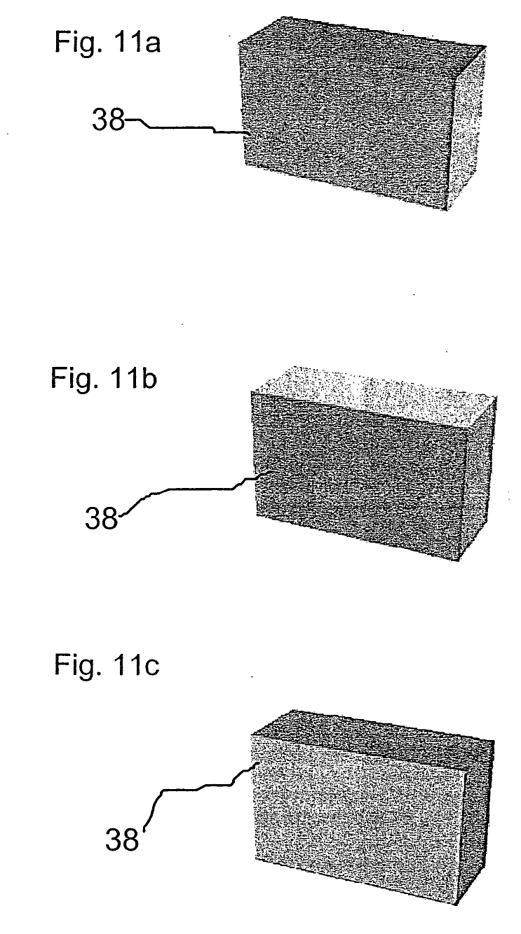

Reference is now made to FIGS. 11a to 11c, which are views of display 20 of FIG. 2 showing various lighting condition of a computer model 38. The lighting conditions of computer model 38 are preferably adjustable to reflect the lighting conditions of the scene captured by camera 21 (FIG. 3). For example, computer model 38 is adjustable to reflect the direction and intensity of the incident sunrays on the surfaces of computer model 38. In FIGS. 11a to 11c, the direction and intensity of the incident sun rays is represented by an arrow. Additionally, the color of computer model 38, the thickness of the lines of computer model 38 and the contrast between computer model 38 and the target object as viewed on display 20 are adjustable. For example, the color of computer model 38 is adjusted so that computer model 38 adopts the appearance of an infrared image when applicable.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art which would occur to persons skilled in the art upon reading the foregoing description.

In particular, the present invention can be used to identify regions which are not clearly visible due to poor visibility, perspective problems or situations where the point or region of interest is out of view, for example, but not limited to, when the point of interest is on a side of the object which is not in view.

1. A method for identifying a target region of a three-dimensional object in a two-dimensional image using a predetermined three-dimensional computer model which includes a plurality of main features of the three-dimensional object, comprising the steps of:
(a) designating the target region on the computer model;
(b) capturing a real scene which includes at least part of the three-dimensional object;
(c) displaying a two-dimensional representation of said real scene together with a view of the computer model; and
(d) allowing a user to manipulate the computer model by at least one of sizing, translating and rotating, such that a view of the computer model and at least a partial view of the three-dimensional object are substantially superimposed, in order to identify the target region in said two-dimensional representation.

2. The method of claim 1, further comprising the step of sending data of said target region in said two-dimensional representation to an automated system.

3. The method of claim 1, further comprising the step of adjusting a level of detail of the computer model.

4. The method of claim 1, further comprising the step of adjusting lighting conditions of the computer model.

5. A method for identifying a physical position of a region of a three-dimensional object from a two-dimensional image including the three-dimensional object using a predetermined three-dimensional computer model which includes a plurality of main features of the three-dimensional object, comprising steps of:
(a) capturing a real scene which includes at least part of the three-dimensional object;
(b) displaying a two-dimensional representation of said real scene together with a view of the computer model; and
(c) allowing a user to manipulate the computer model by at least one of sizing, translating and rotating, such that a view of the computer model and at least a partial view of the three-dimensional object are substantially superimposed, in order to identify the physical position of the region of the three-dimensional object.

6. The method of claim 5, further comprising the step of designating the region on the computer model.

7. The method of claim 5, further comprising the step of sending data of the physical position of the region to an automated system.

8. The method of claim 5, further comprising the step of adjusting a level of detail of the computer model.

9. The method of claim 5, further comprising the step of adjusting lighting conditions of the computer model.

10. A system for facilitating user designation of a target region of a three-dimensional object viewed in a two-dimensional image using a predetermined three-dimensional computer model which includes a plurality of main features of the three-dimensional object, the system comprising:
(a) a camera configured for capturing a real scene which includes at least part of the three-dimensional object;
(b) a computer system having a processor, display device and input device, said camera being operationally connected to said computer system, wherein said processor is configured:
(i) to display on said display device a two-dimensional representation of said real scene together with a view of the computer model;
(ii) to respond to a user input via said input device so as to allow a user to manipulate said view of the computer model by at least one of sizing, translating and rotating; and
(iii) to receive a designation input from the user indicative that a current view of the computer model and the at least partial view of the three-dimensional object are substantially superimposed, thereby determining a position of the target region of the three-dimensional object.

11. The system of claim 10, further comprising an automated system operationally connected to said computer system, said automated system configured for processing data of the target region.

12. The method of claim 10, wherein said input device and said processor are configured for allowing a user to adjust a level of detail of the computer model.

13. The method of claim 10, wherein said input device and said processor are configured for allowing a user to adjust lighting conditions of the computer model.
